(19) United States
(12) Patent Application Publication
(10) Pub. No.: US 2014/0187212 A1
(43) Pub. Date: Jul. 3, 2014

(54) RINGTONE PROCESSING METHOD AND APPARATUS

(71) Applicant: HUAWEI TECHNOLOGIES CO., LTD., Shenzhen (CN)

(72) Inventor: Xuefeng DONG, Milan (IT)

(73) Assignee: HUAWEI TECHNOLOGIES CO., LTD., Shenzhen (CN)

(21) Appl. No.: 14/077,668

(22) Filed: Nov. 12, 2013

(30) Foreign Application Priority Data
Dec. 31, 2012 (CN) 201210590241.7

(51) Int. Cl. H04M 1/57; H04W 4/16

(52) U.S. Cl. CPC H04M 1/575; H04W 4/16
USPC 455/414.1

(57) ABSTRACT

Embodiments of the present invention provide a ringtone processing method and apparatus. In the ringtone processing method according to the embodiments of the present invention, by using a predefined ringing rule, when a call request is received, corresponding ringing information is obtained from the predefined ringing rule according to a calling number and current time information, thereby implementing processing of the current call request according to the calling number and the current time information, and ensuring that a user can receive a call from an important contact and is not disturbed during leisure time by a nuisance call.

### CROSS-REFERENCE TO RELATED APPLICATIONS

This application claims priority to Chinese Patent Application No. 201210590241.7, filed on Dec. 31, 2012, which is hereby incorporated by reference in its entirety.

### TECHNICAL FIELD

Embodiments of the present invention relate to the communications technologies, and in particular, to a ringtone processing method and apparatus.

### BACKGROUND

At present, a mobile phone becomes a necessity in people's lives. People may set a ringtone according to different contacts in use. However, even though a ringtone is set according to different contacts, a user may receive a nuisance call at leisure time, for example, at night or during midday rest, which affects the leisure of the user.

### SUMMARY

Embodiments of the present invention provide a ringtone processing method and apparatus to process a current call request according to a calling number and current time information.

In a first aspect, an embodiment of the present invention provides a ringtone processing method, including:
receiving a call request and obtaining a calling number of the call request;
querying whether a corresponding contact exists in an address book according to the calling number;
if the corresponding contact is found, obtaining current time information;
querying a predefined ringing rule according to the calling number and the current time information to obtain corresponding ringing information; and
playing a ringtone according to the ringing information.

In a first possible implementation of the first aspect, the time information includes current time and/or a current date.

In a second possible implementation of the first aspect, after the querying whether a corresponding contact exists in an address book according to the calling number, the method further includes:
if no corresponding contact is found, obtaining default ringing information.

According to the first aspect, and the first and second possible implementations of the first aspect, in a third possible implementation of the first aspect, the querying a predefined ringing rule according to the calling number and the current time information to obtain corresponding ringing information includes:
querying the predefined ringing rule for a corresponding number ringing rule according to the calling number;
according to the current time information, querying the corresponding number ringing rule for a time segment to which the current time information belongs; and
obtaining a ringtone type and ringing volume corresponding to the time segment and using them as the ringing information.

In a second aspect, an embodiment of the present invention provides a ringtone processing apparatus, including:
a receiving module, configured to receive a call request;
a calling number querying module, configured to obtain a calling number of the call request, and query whether a corresponding contact exists in an address book according to the calling number;
a time information querying module, configured to obtain current time information if the corresponding contact is found;
a ringing information querying module, configured to query a predefined ringing rule according to the calling number and the current time information to obtain corresponding ringing information; and
a ringing performing module, configured to play a ringtone according to the ringing information.

In a first possible implementation of the second aspect, the current time information includes current time and/or a current date.

In a second possible implementation of the second aspect, the ringtone processing apparatus further includes:
a default ringing module, configured to obtain default ringing information if no corresponding contact is found.

According to the second aspect, and the first and second possible implementations of the second aspect, in a third possible implementation of the second aspect, the ringing information querying module includes:
a ringing rule querying unit, configured to query the predefined ringing rule for a corresponding number ringing rule according to the calling number;
a time segment querying unit, configured to query, according to the current time information, the corresponding number ringing rule for a time segment to which the current time information belongs; and
a ringing information obtaining unit, configured to obtain a ringtone type and ringing volume corresponding to the time segment and using them as the ringing information.

In the ringtone processing method and apparatus according to the embodiments of the present invention, by using a predefined ringing rule, when a call request is received, corresponding ringing information is obtained from the predefined ringing rule according to a calling number and current time information, and a ringing device plays a ringtone according to the ringing information, thereby implementing processing of the current call request according to the calling number and the current time information, and ensuring that a user can receive a call from an important contact and is not disturbed during leisure time by a nuisance call.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a ringtone processing method according to Embodiment 1 of the present invention;

FIG. 2a is a first schematic diagram applicable to a predefined ringing rule setting method in the ringtone processing method according to Embodiment 1 of the present invention;

FIG. 2b is a second schematic diagram applicable to a predefined ringing rule setting method in the ringtone processing method according to Embodiment 1 of the present invention;

FIG. 2c is a third schematic diagram applicable to a predefined ringing rule setting method in the ringtone processing method according to Embodiment 1 of the present invention;

FIG. 3 is a flowchart of a ringtone processing method according to Embodiment 2 of the present invention;

FIG. 4 is a fourth schematic diagram applicable to a ringtone processing method according to Embodiment 3 of the present invention;

FIG. 5a is a fifth schematic diagram applicable to a ringtone processing method according to Embodiment 4 of the present invention;

FIG. 5b is a sixth schematic diagram applicable to a ringtone processing method according to Embodiment 4 of the present invention; and

FIG. 6 is a schematic structural diagram of a ringtone processing apparatus according to an embodiment of the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

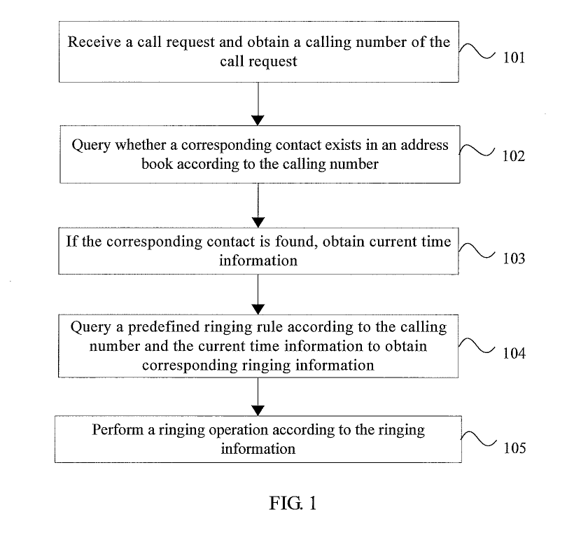

FIG. 1 is a flowchart of a ringtone processing method according to Embodiment 1 of the present invention. The method according to the embodiment is executed by a ringtone processing apparatus, where the apparatus generally is implemented in a hardware and/or software mode and is integrated in a mobile phone device. As shown in FIG. 1, the ringtone processing method according to the embodiment may include the following:

Step 101: Receive a call request and obtain a calling number of the call request.

Step 102: Query whether a corresponding contact exists in an address book according to the calling number.

Step 103: If the corresponding contact is found, obtain current time information.

In the foregoing step, the current time information preferentially includes current time and/or a current date.

Step 104: Query a predefined ringing rule according to the calling number and the current time information to obtain corresponding ringing information.

In this step, the predefined ringing rule may be set by a user, where ringtone information corresponding to the predefined ringing rule may be determined according to the calling number and the current time information. For example, a set calling number and a set time segment may correspond to set ringing information. Regarding a contact corresponding to the same calling number, mute ringing information may be selected for evenings while a ringtone may be selected for working hours.

Step 105: Play a ringtone according to the ringing information.

Specifically, the ringing information may include a ringtone type and ringing volume, where a ringing device may play a ringtone according to the ringing information.

In the ringtone processing method according to the embodiments, by using a predefined ringing rule, when a call request is received, corresponding ringing information is obtained from the predefined ringing rule according to a calling number and current time information, and a ringing device plays a ringtone according to the ringing information, thereby implementing processing of the current call request according to the calling number and the current time information, and ensuring that a user can receive a call from an important contact and is not disturbed during leisure time by a nuisance call.

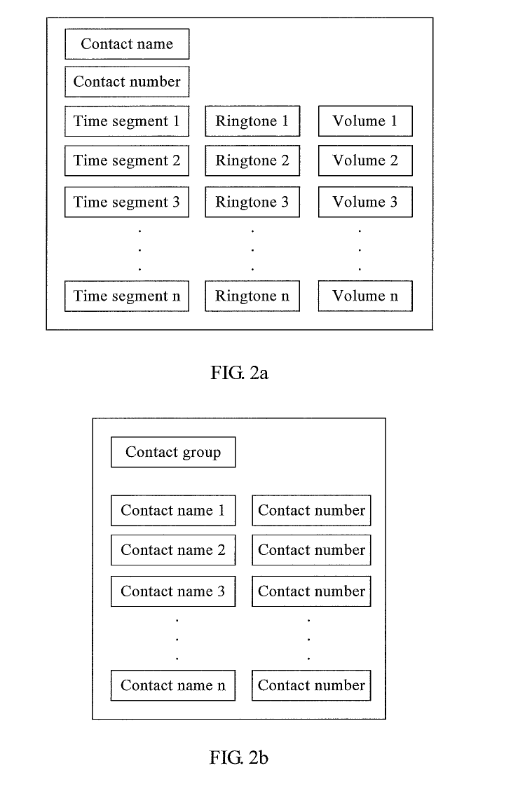

On the basis of the foregoing solution, the setting of the predefined ringing rule may be: for each contact category, adding settings of the parameters: time segment, ringtone, and volume, where the time segment may be set by a user according to requirements, and then a ringtone and a volume corresponding to the time segment are set, as shown in FIG. 2a.

The setting of the predefined ringing rule may also be: a user performs group setting on contacts to set contact groups, as shown in FIG. 2b.

After the contact groups are set, the user may set time segments, ringtones, and volumes regarding different contact groups, as shown in FIG. 2c.

After receiving a call request and querying a calling number of the call request and current time information, the ringtone processing apparatus queries the predefined ringing rule according to the calling number and the current time information for ringing information corresponding to the current calling number.

### Embodiment 2

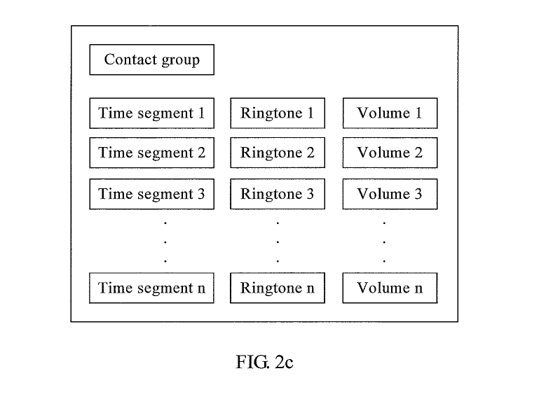

FIG. 3 is a flowchart of a ringtone processing method according to Embodiment 2 of the present invention. As shown in FIG. 3, the ringtone processing method according to the embodiment may include the following:

Step 201: Receive a call request and obtain a calling number of the call request

Step 202: Query whether a corresponding contact exits in an address book according to the calling number, and if yes, perform step 204; if no, perform step 203.

In this step, a ringtone processing apparatus, upon receiving the call request, queries whether a corresponding contact exists in a address book according to the calling number of the call request, and plays a ringtone according to a ringing rule corresponding to the contact if the corresponding contact exists; plays a ringtone according to a default ringing rule if no contact corresponding to the calling number exists.

Step 203: Obtain default ringing information and then perform step 208.

Specifically, if the determining result in step 202 is negative, that is, the ringtone processing apparatus finds no contact corresponding to the calling number of the call request in the address book, the default ringing information is obtained, and the ringing information is provided for a ringing device to play a ringtone.

Step 204: Obtain current time information.

Step 205: Query a predefined ringing rule for a corresponding number ringing rule according to the calling number.

Specifically, after querying that the contact corresponding to the calling number of the call request exists in the address book, the ringtone processing apparatus further queries a corresponding number ringing rule according to the calling number, where the number ringing rule may be a setting set by a user about a corresponding time segment, ringtone, and volume regarding different contacts.

Step 206: According to the current time information, query the corresponding number ringing rule for a time segment to which the current time information belongs.

In this step, the ringtone processing apparatus may query, according to the current time information, the number ringing rule corresponding to the calling number for a time segment to which the time information belongs. Specifically, the user may set a ringing rule for different time segments according to different contacts, for example, set the number ringing rule corresponding to a phone number of an important contact as ringing in all time segments, and set a number ringing rule corresponding to a phone number of an unimportant contact as ringing during working hours and vibrating or mute during leisure time.

Step 207: Obtain a ringtone type and ringing volume that are corresponding to the time segment and using them as the ringing information.

Step 208: Play a ringtone according to the ringing information.

In order to describe the ringtone processing method more specifically, the following further specifically describes the ringtone processing method by using several specific embodiments.

### Embodiment 3

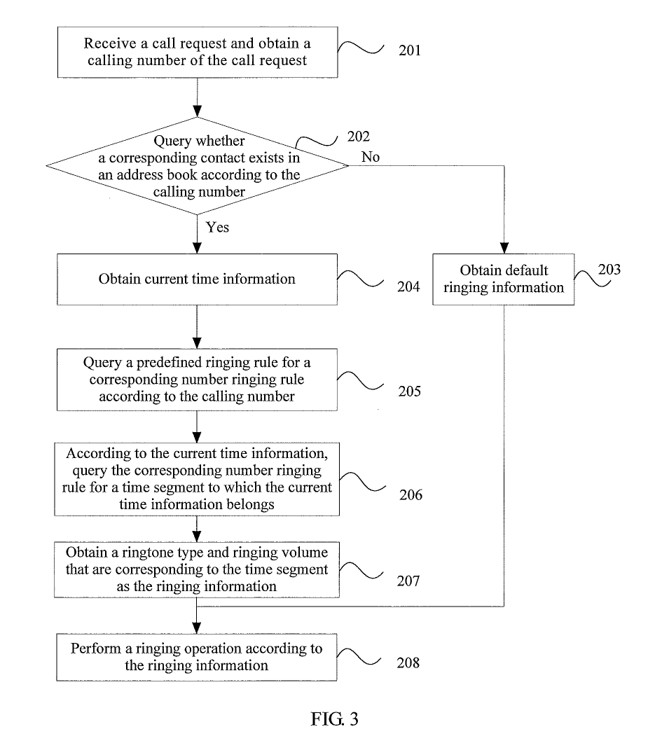

Embodiment 3 of the present invention provides an exemplary embodiment of a calling ringtone processing method. Regarding a contact John, a user may set a setting shown in FIG. 4 in a address book.

Specifically, a ringtone processing apparatus, upon receiving a call request, queries and finds that a calling number of the call request belongs to the contact John and that current time information belongs to a time segment 08:01-8:00; the ringtone processing apparatus queries a predefined ringing rule for a corresponding number ringing rule and obtains corresponding ringing information, that is, ringtone 1 and volume level 5; the ringtone processing apparatus provides the ringing information for a ringing device; and the ringing device plays ringtone 1 according to the ringing information.

If the time information of the call request of the contact John belongs to a time segment 18:01-21:00, corresponding ringing information obtained by the ringtone processing apparatus is ringtone 2 and volume level 3; the ringtone processing apparatus provides the ringing information for the ringing device; and the ringing device plays ringtone 2 according to the ringing information.

If the time information of the call request of the contact John belongs to a time segment other than 08:01-18:00 and 18:01-21:00, corresponding ringing information obtained by the ringtone processing apparatus is ringtone 1 and a mute volume; the ringtone processing apparatus provides the ringing information for the ringing device; and the ringing device plays ringtone 1 according to the ringing information.

### Embodiment 4

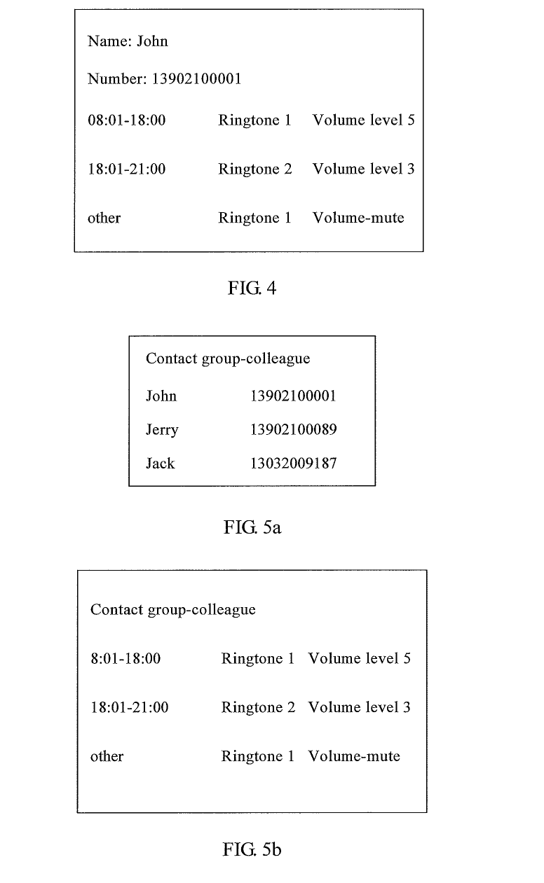

Embodiment 4 of the present invention provides another exemplary embodiment of a calling ringtone processing method. A user sets a contact group in a address book in advance, as shown in FIG. 5a.

Further, a user sets a setting shown in FIG. 5b regarding the contact group.

Specifically, a ringtone processing apparatus, upon receiving a call request, queries and finds that a calling number of the call request belongs to a contact John, the contact John belongs to a contact group-colleague, and current time information belongs to a time segment 08:01-18:00; the ringtone processing apparatus queries a predefined ringing rule for a corresponding number ringing rule and obtains corresponding ringing information, that is, ringtone 1 and volume level 5; the ringtone processing apparatus provides the ringing information for a ringing device; and the ringing device plays ringtone 1 according to the ringing information.

If the ringtone processing apparatus, upon receiving the call request, queries that a calling number of the call request belongs to a contact Jack, the contact Jack belongs to a contact group-colleague, and current time information belongs to a time segment 18:01-21:00, the ringtone processing apparatus queries a predefined ringing rule for a corresponding number ringing rule and obtains corresponding ringing information, that is, ringtone 2 and volume level 3; the ringtone processing apparatus provides the ringing information for a ringing device; and the ringing device plays ringtone 2 according to the ringing information.

If the ringtone processing apparatus, upon receiving the call request, queries that a calling number of the call request belongs to a contact Jerry, the contact Jerry belongs to a contact group-colleague, and current time information belongs to a time segment 21:01-07:59 instead of the time segment 08:01-18:00 or the time segment 18:01-21:00, the ringtone processing apparatus queries a predefined ringing rule for a corresponding number ringing rule and obtains corresponding ringing information, that is, ringtone 1 and a mute volume; the ringtone processing apparatus provides the ringing information for a ringing device; and the ringing device plays ringtone 1 according to the ringing information.

In the ringtone processing method according to the embodiment, by using a predefined ringing rule, when a call request is received, corresponding ringing information is obtained from the predefined ringing rule according to a calling number and current time information, thereby implementing processing of the current call request according to the calling number and the current time information, and ensuring that a user can receive a call from an important contact and is not disturbed during leisure time by a nuisance call.

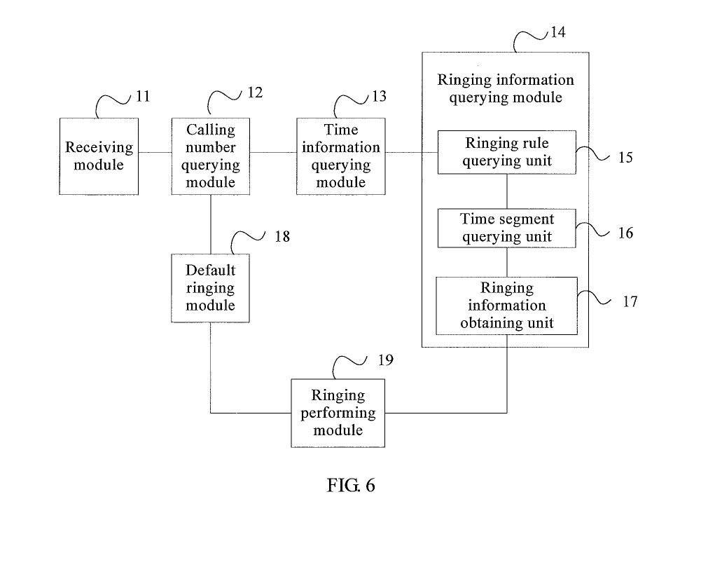

FIG. 6 is a schematic structural diagram of a ringtone processing apparatus according to an embodiment of the present invention. As shown in FIG. 6, the ringtone processing apparatus according to the embodiment may include a receiving module 11, a calling number querying module 12, a time information querying module 13, a ringing information querying module 14, and a ringing performing module 19.

The receiving module 11 is configured to receive a call request; the calling number querying module 12 is configured to obtain a calling number of the call request, and query whether a corresponding contact exists in an address book according to the calling number; the time information querying module 13 is configured to obtain current time information if the corresponding contact is found; the ringing information querying module 14 is configured to query a predefined ringing rule according to the calling number and the current time information to obtain corresponding ringing information; and the ringing performing module 19 is configured to play a ringtone according to the ringing information.

Specifically, on the basis of the technical solution of the embodiment, the current time information includes current time and/or a current date.

Specifically, on the basis of the technical solution of the embodiment, the ringtone processing apparatus according to the embodiment of the present invention may further include:
a default ringing module 18, configured to obtain default ringing information if no corresponding contact is found.

Specifically, on the basis of the technical solution of the embodiment, in the ringtone processing apparatus according to the embodiment of the present invention, the ringing information querying module 14 includes:
a ringing rule querying unit 15, configured to query the predefined ringing rule for a corresponding number ringing rule according to the calling number;
a time segment querying unit 16, configured to query, according to the current time information, the corresponding number ringing rule for a time segment to which the current time information belongs; and
a ringing information obtaining unit 17, configured to obtain a ringtone type and ringing volume corresponding to the time segment and using them as the ringing information.

The ringtone processing apparatus according to the embodiment of the present invention may be configured to execute the ringtone processing method according to any embodiment of the present invention, and has corresponding functional modules and benefits, which is not described repeatedly herein.

A person of ordinary skill in the art may understand that, all or a part of the steps of the foregoing method embodiments may be implemented by a program instructing relevant hardware. The foregoing programs may be stored in a computer readable storage medium. When the program runs, the steps of the forgoing method embodiments are performed. The foregoing storage medium includes various mediums capable of storing program codes, such as a ROM, a RAM, a magnetic disk, or an optical disc.

Finally, it should be noted that the foregoing embodiments are merely intended for describing the technical solutions of the present invention, other than limiting the present invention. Although the present invention is described in detail with reference to the foregoing embodiments, a person of ordinary skill in the art should understand that he may still make modifications to the technical solutions described in the foregoing embodiments, or make equivalent replacements to some or all the technical features thereof, without departing from the spirit and scope of the technical solutions of the embodiments of the present invention.

What is claimed is:

1. A ringtone processing method, comprising:
receiving a call request and obtaining a calling number of the call request;
querying whether a corresponding contact exists in an address book according to the calling number;
if the corresponding contact is found, obtaining current time information;
querying a predefined ringing rule according to the calling number and the current time information to obtain corresponding ringing information; and
playing a ringtone according to the ringing information.

2. The ringtone processing method according to claim 1, wherein the time information comprises current time and/or a current date.

3. The ringtone processing method according to claim 1, wherein after the querying whether a corresponding contact exists in an address book according to the calling number, the method further comprises:
if no corresponding contact is found, obtaining default ringing information.

4. The ringtone processing method according to claim 1, wherein the querying a predefined ringing rule according to the calling number and the current time information to obtain corresponding ringing information comprises:
querying the predefined ringing rule for a corresponding number ringing rule according to the calling number;
according to the current time information, querying the corresponding number ringing rule for a time segment to which the current time information belongs; and
obtaining a ringtone type and ringing volume corresponding to the time segment and using them as the ringing information.

5. A ringtone processing apparatus, comprising:
a receiving module, configured to receive a call request;
a calling number querying module, configured to obtain a calling number of the call request, and query whether a corresponding contact exists in an address book according to the calling number;
a time information querying module, configured to obtain current time information if the corresponding contact is found;
a ringing information querying module, configured to query a predefined ringing rule according to the calling number and the current time information to obtain corresponding ringing information; and
a ringing performing module, configured to play a ringtone according to the ringing information.

6. The ringtone processing apparatus according to claim 5, wherein the current time information comprises current time and/or a current date.

7. The ringtone processing apparatus according to claim 5, further comprising:
a default ringing module, configured to obtain default ringing information if no corresponding contact is found.

8. The ringtone processing apparatus according to claim 5, wherein the ringing information querying module comprises:
a ringing rule querying unit, configured to query the predefined ringing rule for a corresponding number ringing rule according to the calling number;
a time segment querying unit, configured to query, according to the current time information, the corresponding number ringing rule for a time segment to which the current time information belongs; and
a ringing information obtaining unit, configured to obtain a ringtone type and ringing volume corresponding to the time segment and using them as the ringing information.
